(19) United States
(12) Patent Application Publication
(10) Pub. No.: US 2005/0240536 A1
(43) Pub. Date: Oct. 27, 2005

(54) Networked electronic trading system

(76) Inventors: Michael Davis, Antwerpen (BE); Ronald DuCros, Surrey (GB)

Correspondence Address: NEIFELD IP LAW, PC, 4813-B EISENHOWER AVENUE, ALEXANDRIA, VA, 22304, US

(21) Appl. No.: 11/113,131

(22) Filed: Apr. 25, 2005

(30) Foreign Application Priority Data
Apr. 26, 2004 (GB) 0409262.3

(51) Int. Cl. G06F 17/60; E04D 13/00; H04K 1/00; H04L 9/00

(52) U.S. Cl. 705/75; 705/51

(57) ABSTRACT

There is described a networked electronic trading system in which an administration server approves each trade of electronic data corresponding to a copyright-protected work between clients of the networked electronic trading system. The administration server has a database which stores information for a plurality of electronic data files, the information for each electronic data file including a list identifying registered traders of the electronic data files. The administration server processes transaction request information identifying a buyer, a seller and an electronic data file. The administration server approves the sale of the identified electronic data file by the seller to the buyer at least partially in dependence upon if the seller is identified in the registered traders list for the electronic data file. If the transaction is approved, the administration server adds information identifying the buyer to the registered traders list for the electronic data file.

This application claims the right to priority under 35 U.S.C. §119 based on British Patent Application Number 0409262.3, which is hereby incorporated by reference herein in its entirety as if fully set forth herein.

### FIELD OF THE INVENTION

This invention relates to a networked electronic trading system in which transactions take place between the members (hereafter called clients) of the trading system. The invention has particular, but not exclusive, relevance to a networked electronic trading system in which one client sells a digital content file comprising electronic data corresponding to a copyright-protected work (e.g. data for a song or a movie) to another client.

### BACKGROUND OF THE INVENTION

With the rapid increase in usage of the Internet in the past decade, a problem has arisen in that some users have exploited the data transfer capabilities of the Internet to distribute illegal digitised copies of copyright-protected works. For example, file-sharing systems have been established which allow participants to download electronic versions of copyright-protected works from each other free of charge.

Many measures have been taken to combat this illegal distribution of copyright-protected electronic data, ranging from technical measures (generally termed digital rights management) to enforcement in the courts. A problem with digital rights management is that any technical advance in protection is swiftly countered by a corresponding technical advance on behalf of the illegal copiers. A problem with enforcement in the courts is the cost associated with prosecuting large numbers of individuals when only a relatively small amount of money may be recovered from each individual.

### SUMMARY OF THE INVENTION

The present inventors have come to the conclusion that digital rights management will not provide a long-term satisfactory solution to combat illegal distribution of copyright-protected electronic data. The present inventors therefore propose a radical change of approach, namely to allow the distribution of copies of copyright-protected electronic data over the internet providing appropriate copyright payments are made. Further, in order to encourage individuals to pay the copyright payments, the present inventors propose that purchasers of electronic data corresponding to a copyright-protected work should be allowed to sell copies of the purchased electronic data and keep a portion of the sale price for themselves. While it is accepted that such an approach will not eliminate the illegal distribution of electronic versions of copyright-protected works, it is envisaged that it will significantly reduce the level of illegal distribution as previous illegal copiers decide to make money from distributing electronic copies instead.

The present inventors have addressed the technical problem of how to implement the approach in a networked electronic trading system.

According to an aspect of the invention, an administration server is provided which approves each trade of electronic data corresponding to a copyright-protected work between clients of a networked electronic trading system.

Preferably, the administration server also handles the transfer of money between the client buyer and the client seller while ensuring that a royalty payment is made to any registered copyright holders. In this way, the administration server checks both that the client seller has the right to sell the electronic data (which may either be by virtue of being the copyright owner or by having bought a legitimate copy) and that the client buyer has paid the appropriate copyright payment. Preferably, the administration server maintains a database logging each data file storing electronic data for a copyright-protected work with a list of clients who are legitimate owners of the data file. In this way, each time a transaction request is received by the client the administration server is able to check that the client seller is a legitimate owner of the data file identified in the transaction request.

Preferably, in addition to paying a copyright payment to the copyright holders out of a sale price for a copy of a data file, the administration server also makes a payment to the original submitter of the data file. In this way, the addition of data files to the networked electronic trading system is encouraged.

According to another aspect of the invention, there is provided a computing apparatus which offers for sale data files corresponding to copyright-protected works. After receiving a purchase offer from a remote computing apparatus, computing apparatus sends details of the proposed transaction to a remote administration server and awaits a response from the administration server. If the response indicates approval of the transaction then the computing apparatus sends the digital content file to the remote computing apparatus, whereas if the response does not indicate approval of the transaction then the transaction is terminated.

According to a further aspect of the invention, there is provided a computing apparatus which includes a browser for finding data files corresponding copyright-protected works on remote computing apparatuses. The computing apparatus is operable to transmit a purchase request to a remote computing apparatus and a transaction request to a remote administration server. The computing apparatus subsequently awaits receipt of the data file identified in the purchase request and the transaction request from the remote computing apparatus if the transaction is approved by the remote computing apparatus and the remote administration server.

### BRIEF DESCRIPTION OF THE DRAWINGS

An embodiment of the invention will now be described with reference to the accompanying Figures, in which:

FIG. 1 schematically shows a networked electronic trading system according to the invention;

FIG. 2 shows a flow chart providing an overview of the operations performed to carry out a series of two transactions on the networked electronic trading system illustrated in FIG. 1;

FIG. 3 is a block diagram schematically showing the main functional components of an administration server forming part of the networked electronic trading system illustrated in FIG. 1;

FIG. 4 schematically shows the configuration of a client database forming part of the administration server illustrated in FIG. 2;

FIG. 5 schematically shows the configuration of a client form forming part of the client database illustrated in FIG. 4;

FIG. 6 schematically shows the configuration of a content database forming part of the administration server illustrated in FIG. 2;

FIG. 7 schematically shows the configuration of a digital content form forming part of the content database illustrated in FIG. 6;

FIG. 8 schematically shows the configuration of a transaction database forming part of the administration server illustrated in FIG. 2;

FIG. 9 schematically shows the configuration of a transaction form forming part of the transaction database illustrated in FIG. 8;

FIG. 10 schematically shows the configuration of a disputed content database forming part of the administration server illustrated in FIG. 2;

FIG. 11 schematically shows the configuration of a dispute form forming part of the disputed content database illustrated in FIG. 10;

FIG. 12 is a block diagram showing the main functional components relating to the networked electronic trading system of a client computer forming part of the networked electronic trading system illustrated in FIG. 1;

FIG. 13 schematically shows the configuration of an account database forming part of the client computer illustrated in FIG. 12;

FIG. 14 schematically shows the configuration of an account form forming part of the account database illustrated in FIG. 13;

FIG. 15 schematically shows the configuration of a content database forming part of the client computer illustrated in FIG. 12;

FIG. 16 schematically shows the configuration of a digital content form forming part of the content database illustrated in FIG. 15;

FIG. 17 shows a flowchart illustrating the main operations performed to register a new client to the networked electronic trading system illustrated in FIG. 1;

FIG. 18 shows a flowchart illustrating the operations performed to add a new content file to the networked electronic trading system illustrated in FIG. 1; and

FIGS. 19A to 19E show a flowchart illustrating the main operations performed when one client of the networked electronic trading system illustrated in FIG. 1 sells a digital content file to another client.

### DETAILED DESCRIPTION

System Overview

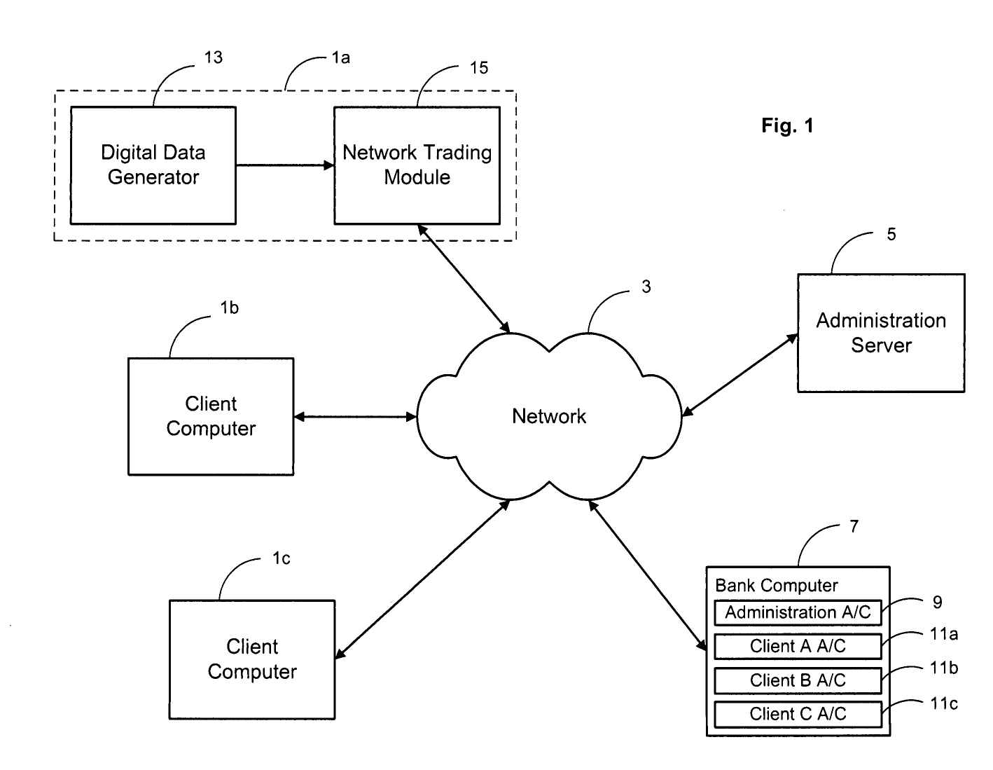

FIG. 1 schematically shows the main components of a networked electronic trading system according to the invention. A plurality of client computers 1a-1c, three of which are illustrated in FIG. 1, are connected to a network 3, which in this embodiment forms part of the internet. An administration server 5 which manages the networked electronic trading system is also connected to the network 3.

One or more clients of the networked electronic trading system are associated with each client computer 1. In this embodiment, a client A is associated with a first client computer 1a, a client B is associated with a second client computer 1b and a client C is associated with a third client computer 1c.

A bank computer 7 offering an on-line banking facility is also connected to the network 3. For ease of explanation, in this embodiment the online banking facility includes data for an administration account 9, which is used by the administration server 5, and data for three client accounts 11a to 11c for client A, client B and client C respectively. It will be appreciated that the administration account 9 and the client accounts 11 could alternatively be distributed among multiple online banking facilities.

As shown in FIG. 1 for the first client computer 1a, each client computer 1 includes a digital data generator 13 which is connected to a network trading module 15. The digital data generator 13 is used to create a digital content file storing electronic data corresponding to a work having copyright. The digital data generator 13 could be an original music digital data file generator such as, for example, the GarageBand and Logic Pro products by Apple. Alternatively, the digital data generator 13 could be an original movie digital data file generator such as the iMovie and Final Cut Pro products by Apple. The network trading module 15 is used to interact with other clients of the networked electronic trading system and the administration server 5.

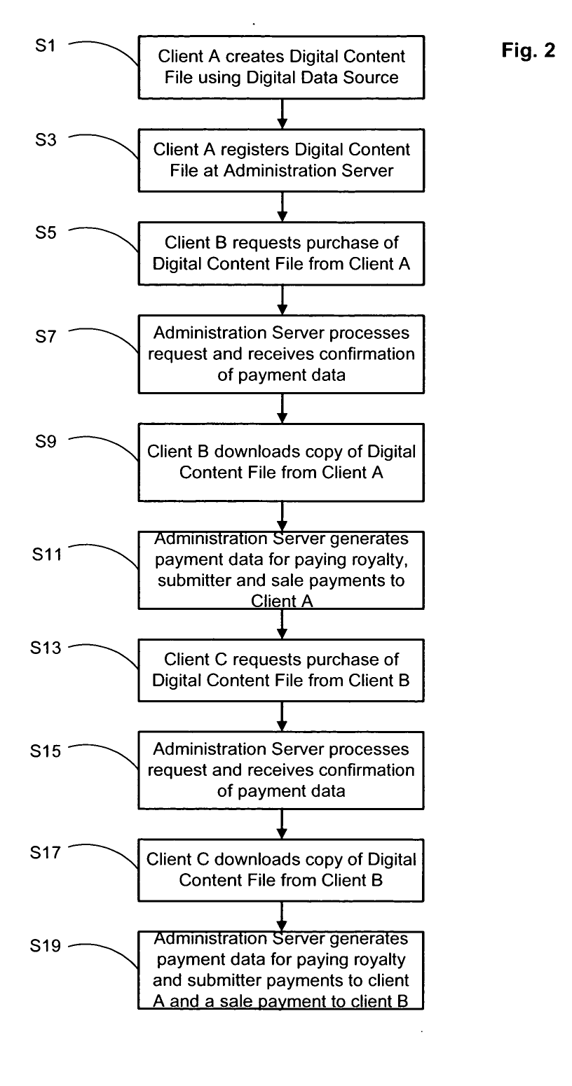

FIG. 2 shows an overview of an illustrative sequence of transactions performed using the networked electronic trading system illustrated in FIG. 1. Initially client A creates, at S1, a digital content file using the digital data generator 13 of the first client computer 1a. Client A then sends, at step S3, registration data for registering the digital content file at the administration server 5. Once the digital content file is registered at the administration server 5, client A is allowed to advertise the digital content file and sell the digital content file to other clients of the networked electronic trading system.

When client B sends, at S5, a request to purchase a copy of the digital content file from client A, the purchase requires approval by the administration server 5, which also handles the monetary transaction. After the administration server 5 processes, at S7, the request to check that the transaction is allowable and receives an electronic message from the bank computer 7 confirming that the purchase cost has been paid by client B into the administration account 9, client B downloads, at S9, a copy of the digital content file from client A. The administration server 5 subsequently generates, at S11, payment data to the bank computer 7 instructing payment of a royalty payment (which is paid to the copyright holder(s)), a submitter payment (which is paid to the original submitter of the digital content file) and a sale payment (which is paid to the seller of the digital content file) into the bank account 11a of client A, and sends the payment data to the bank computer 7.

As part of the processing of the purchase request, in accordance with the invention the administration server 5 records the purchase of the digital content file by client B thereby allowing client B to sell copies of the digital content file. When client C sends, at S13, a request to purchase the digital content file from client B, the administration server 5 processes, at S15, the purchase request to check for allowability and receives an electronic message from the bank computer 7 confirming that client C has paid the purchase price into the administration account 9, then client C downloads, at S17, a copy of the digital content file from client B. Subsequently, the administration server 5 generates, at S19, payment data instructing payment of the royalty payment and the submitter payment into the bank account 11a of client A and the sale payment into the bank account 11b of client B, and sends the payment data to the bank computer 7.

In this way, the networked electronic trading system allows copies of a digital content file to be sold while ensuring that the copyright(s) receives an appropriate copyright payment.

The administration server 5, the client computers 1 and the operations performed by the administration server 5 and the client computers 1 will now be described in more detail.

Administration Server

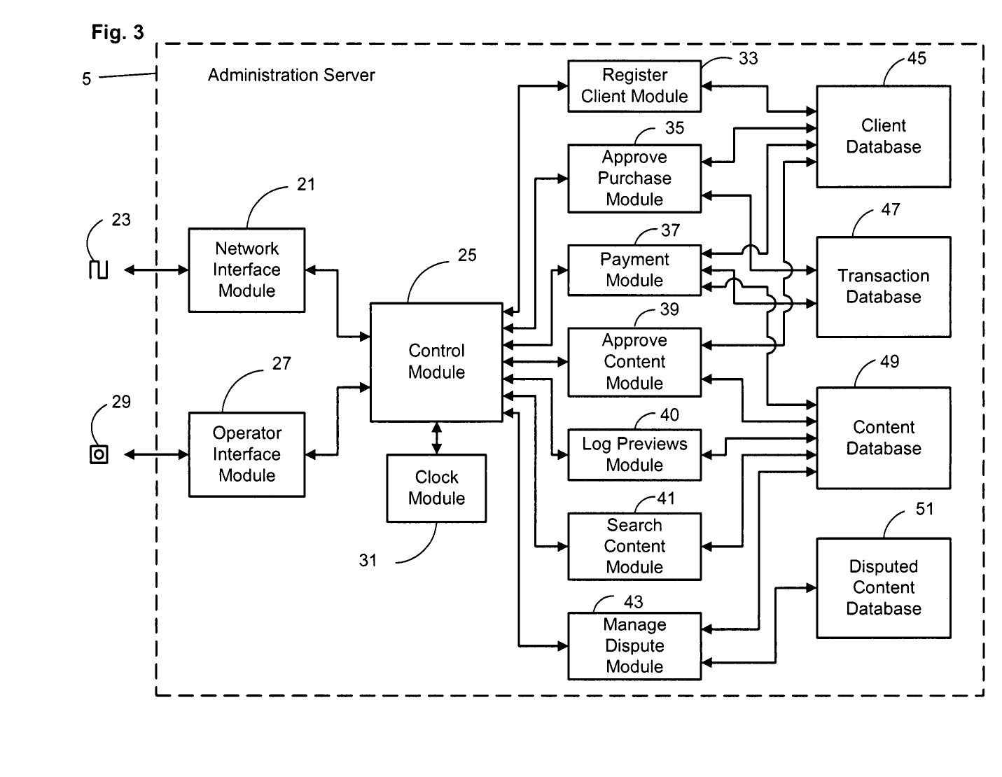

The administration server will now be described with reference to FIGS. 3 to 11. In this embodiment, the administration server is a conventional computing device having a processor, input/output devices and memory interconnected by a computer bus network. FIG. 3 shows the main software modules stored in the administration server 5. For illustrative purposes, software modules which interact with each other are schematically connected.

As shown, the administration server 5 includes a network interface module 21 which processes modulated signals 23 conveying data from the network 3. The network interface module 21 recovers the data from the modulated signals 23 and forwards the data to a control module 25. The network interface module 21 also modulates data for transmission by the administration server 5 over the network.

The administration server 5 also has an operator interface module 27 which processes data input by an operator at the administration server 5 and outputs data to the operator at the administration server 5. In this embodiment the operator interface module 27 processes data read by a CD-ROM reader (not shown) which may be used to read data stored on a CD-ROM 29, and data input by a keyboard and a computer mouse, and generates drive data for a display. Input data processed by the operator interface 27 is subsequently processed by the control module 25.

A clock module 31 provides time signals which are used by the control module 25.

In response to received data processed by the network interface module 21 or the operator interface module 27, or in response to a predetermined time signal received from the clock module 31, the control module 25 initiates one of six functional modules, namely:
a register client module 33 which is used to register a new client to the networked electronic trading system;
an approve purchase module 35 which is used to approve the purchase of a digital content file;
a payment module 37 which is used to instruct payment to the client accounts;
an approve content module 39 which is used to approve the addition of a new digital content file to the networked electronic trading system;
a log previews module 40 which is used if a preview of a digital content file is downloaded;
a search content module 41 which is used to allow one client to identify the digital content files held by other clients; and
a manage dispute module 43 which is used if there is a dispute concerning the ownership of copyright for a digital content file.

Each of the functional modules 33-43 processes the received data and data stored in one or more of four databases stored at the administration server 5, and transmits output signals to the control module 25 for outputting using the network interface module 21 or the operator interface module 27. The four databases are a client database 45, a transaction database 47, a content database 49 and a disputed content database 51.

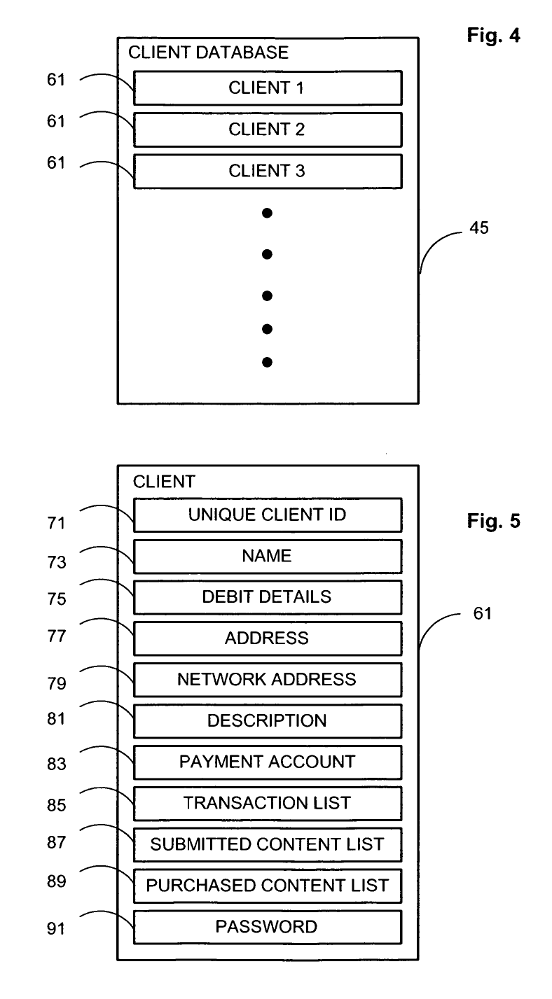

The client database 45 stores details for each of the clients of the networked electronic trading system. As shown in FIG. 4, the client database stores client forms 61 giving details for respective clients. As shown in FIG. 5, each client form 61 stores the following data:
a unique client ID 71 which is assigned to each client of the networked electronic trading system when the client is registered;
the name 73 of the client, which could be a personal name or a company name;
debit details 75 for obtaining payments from the client;
address information 77 for contacting the client, including both postal and email addresses;
a network address 79 via which the client advertises and sells authorised digital content files;
a description 81 given by the client of the type of digital content files owned by the client (e.g. rock music, classical music, action movie etc.);
a payment account 83 into which revenue for the client is paid;
a transaction list 85 containing unique transaction IDs for identifying transactions stored in the transaction database 47 in which the client has participated as either a seller or a buyer;
a submitted content list 87 storing unique content IDs for each digital content file which has been submitted by the client and is stored in the content database 49;
a purchased content list 89 storing the unique content IDs of each digital content file stored in the content database 49 which has been purchased by the client; and
a password 91 which is required to access the account details.

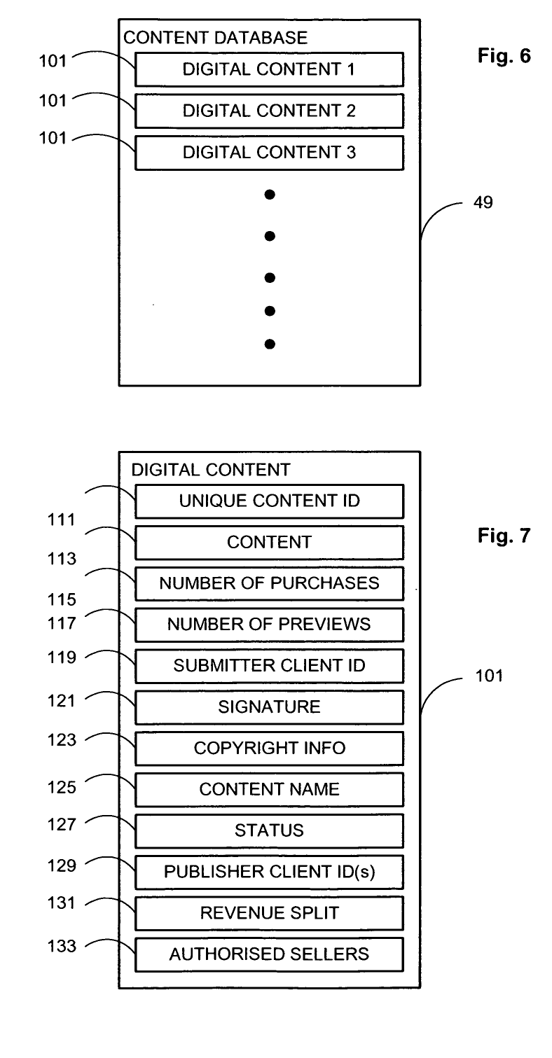

The content database 49 stores details of each digital content file which is authorised for trading on the networked electronic system. As shown in FIG. 6, the content database 49 stores digital content forms 101 for respective digital content files. As shown in FIG. 7, each digital content form 101 stores:
a unique content ID 111 which is assigned to each digital content file when the digital content file is approved for trading on the networked electronic trading system;
content information 113 storing the digital content file itself;
number of purchases information 115 which stores the number of times the digital content file has been purchased;
number of previews information 117 which stores the number of times a preview of a digital content file (i.e. a truncated sample of the digital content file which is downloadable at no cost) has been downloaded;
submitter client ID information 119 storing the unique client ID 71 of the client who originally submitted the digital content file to the networked electronic trading system;
a signature 121 which in this embodiment is a one-way hash of the content of the digital content file produced by the secure hashing algorithm SHA-1;
copyright information 123 storing details of when and how copyright was generated;
content name information 125 storing the name for the digital content file given by the submitter of the digital content file;
a status indicator 127 which indicates the status of the digital content file, which could be PENDING, APPROVED, DISPUTED or REVOKED;
publisher client ID(s) 129 storing the unique client ID(s) of the copyright holder(s) for the digital content file;
a revenue split 131 which indicates how the purchase price of the digital content file is to be distributed between the copyright holder(s), the original submitter and the seller; and
authorised sellers information 133 storing a list of the unique client IDs for the clients of the networked electronic trading system who are authorised to sell the digital content file.

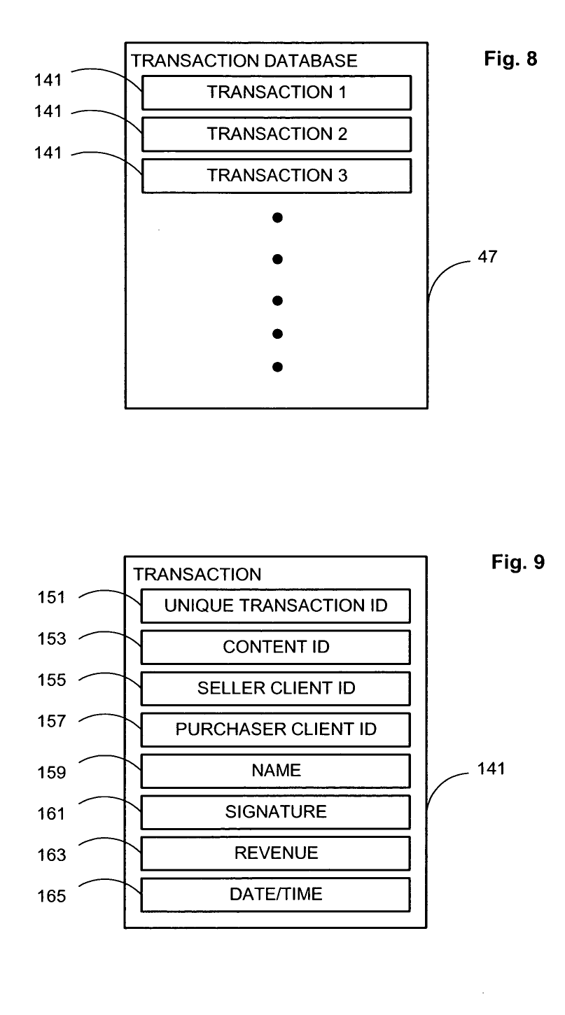

The transaction database 47 stores details of each transaction authorised by the administration server 5. As shown in FIG. 8, the transaction database 47 stores a transaction form 141 for each transaction. As shown in FIG. 9, each transaction form 141 stores:
a unique transaction ID 151 which is assigned by the administration server to the transaction when the transaction takes place;
content ID information 153 which stores the unique content ID 111 for the digital content file which is purchased in the transaction;
seller client ID information 155 which stores the unique client ID 71 of the client who sells the digital content files in the transaction;
purchaser client ID information 157 which stores the unique client ID 71 of the client who purchases the digital content file in the transaction;
content name information 159 which stores the content name 125 of the digital content file purchased in the transaction;
signature information 161 storing the signature of the digital content file purchased in the transaction;
revenue information 163 giving details of the purchase price and how the purchase price was distributed between the copyright holder(s), the original submitter and the seller; and
data/time information 165 indicating when the transaction took place.

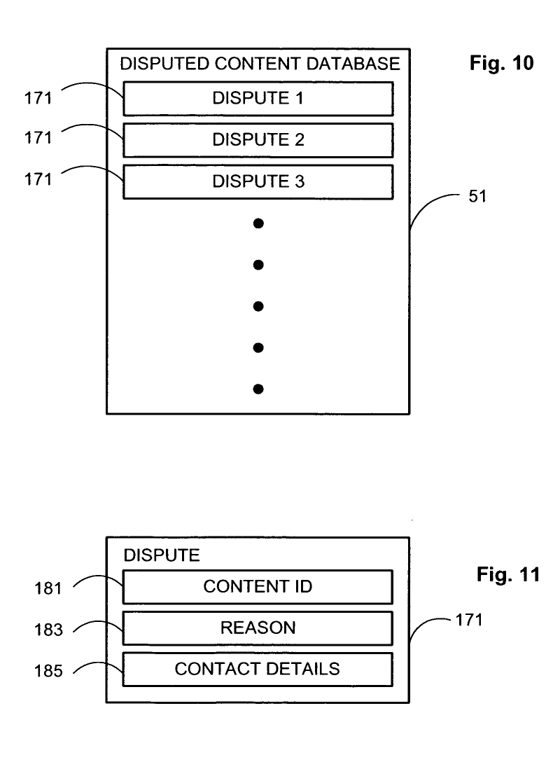

The disputed content database 51 stores details of any disputes over the copyright ownership of a digital content file stored in the content database 49. As shown in FIG. 10, the disputed contents database 51 stores a dispute form 171 for each dispute. As shown in FIG. 11, each dispute form includes
content ID information 181 storing the unique content ID 111 for the digital content file which is the subject of the dispute;
reason information 183 which stores details of the nature of the dispute; and
contact details information 185 which stores contact details for the originator of the dispute.

The operations performed by the six functional modules will be described in more detail after a description of the contents of each client computer 1.

Client Computer

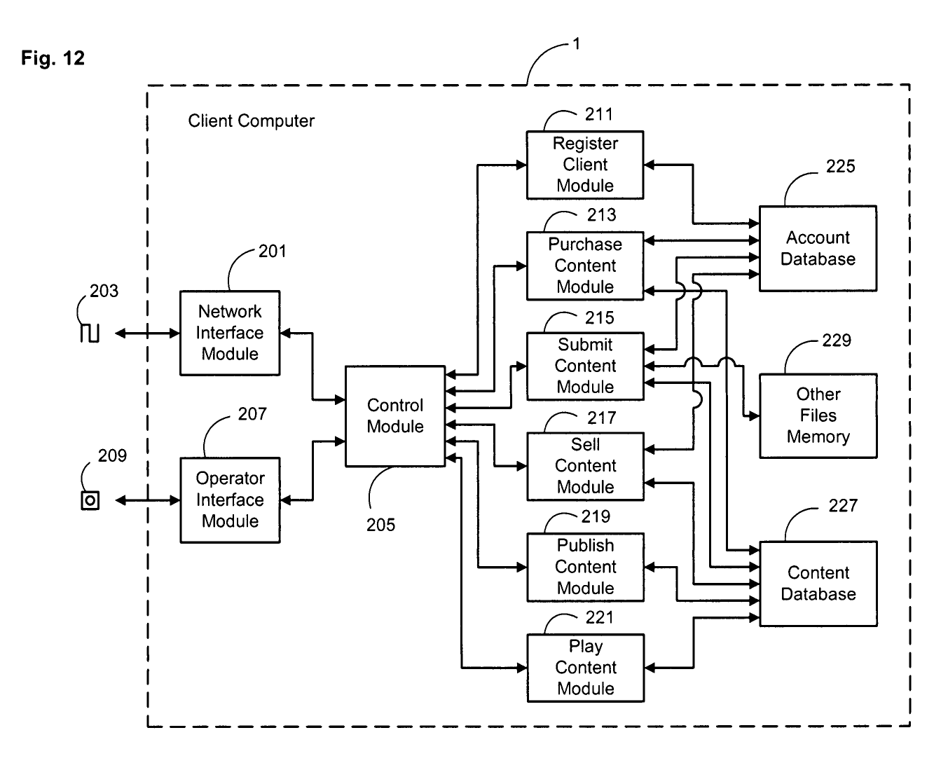

A client computer 1 storing computer software for implementing the networked electronic trading system will now be described with reference to FIGS. 12 to 16. In this embodiment, each client computer 1 could be an Apple Macintosh computer, an IBM-compatible personal computer, a UNIX workstation or the like. Such computing devices are well known and therefore the conventional functional components (including hardware, firmware, operating system and the like) of the client computer 1 will not be described in detail.

FIG. 12 shows the main software modules stored by the client computer 1 relating to the networked electronic trading system. As shown, the client computer 1 has a network interface module 201 which processes modulated signals 203 from the network 3 conveying data in a conventional manner. The network interface module 201 retrieves the data from the modulated signals 203 and forwards the data to a control module 205. The client computer 1 also includes an operator interface module 207 which processes data input by a user of the client computer 1 and outputs data for the user of the client computer 1. The operator interface module 207 processes data read from a CD-ROM 209 by a CD-ROM reader, processes data input by a keyboard and a computer mouse, and generates drive signals for a display in a conventional manner.

On receiving data via the network interface module 201 or the operator interface module 207, the control module 205 is operable to activate, in dependence on the content of the received data, one of six functional modules, namely:
a register client module 211 which is used during the registration of a client to the networked electronic trading system;
a purchase content module 213 which is used during the purchase of a digital content file;
a submit content module 215 which is used to submit a new digital content file to the networked electronic trading system;
a sell content module 217 which is used during the sale of a digital content file;
a publish content module 219 which is used to provide details to another client of digital content files stored by the client computer; and
a play content module 221 which is used to play a digital content file stored by the client computer 1.

The functional modules process received data and data stored in an account database 225, a content database 227 and memory 229 storing other files on the client computer 1, and output signals to the control module 205 for outputting via the network interface 201 or the operator interface 207.

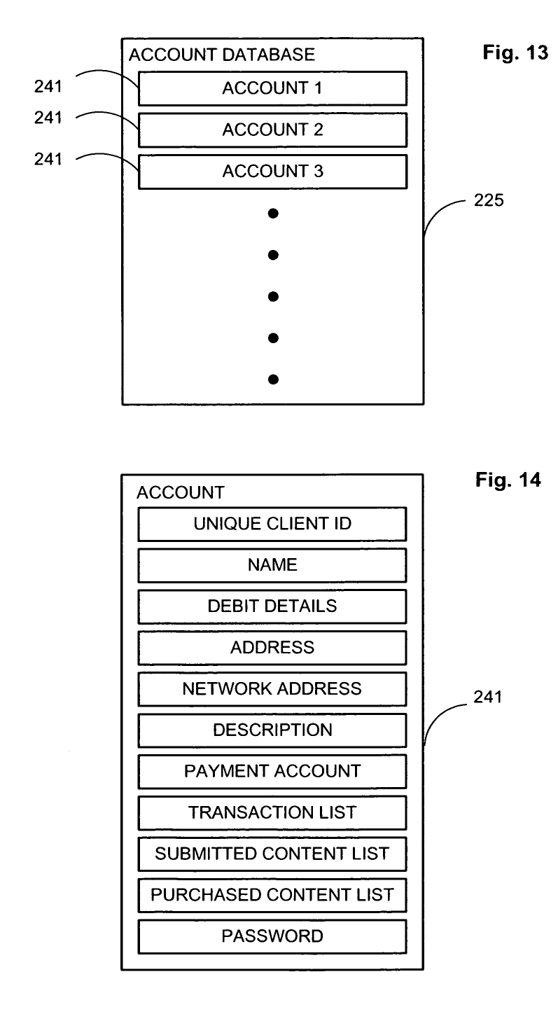

As shown in FIG. 13, the account database stores account forms 241 for each account associated with the client computer 1. As shown in FIG. 14, each account form 241 is identical to the account form 61 stored by the administration server 5 for the client.

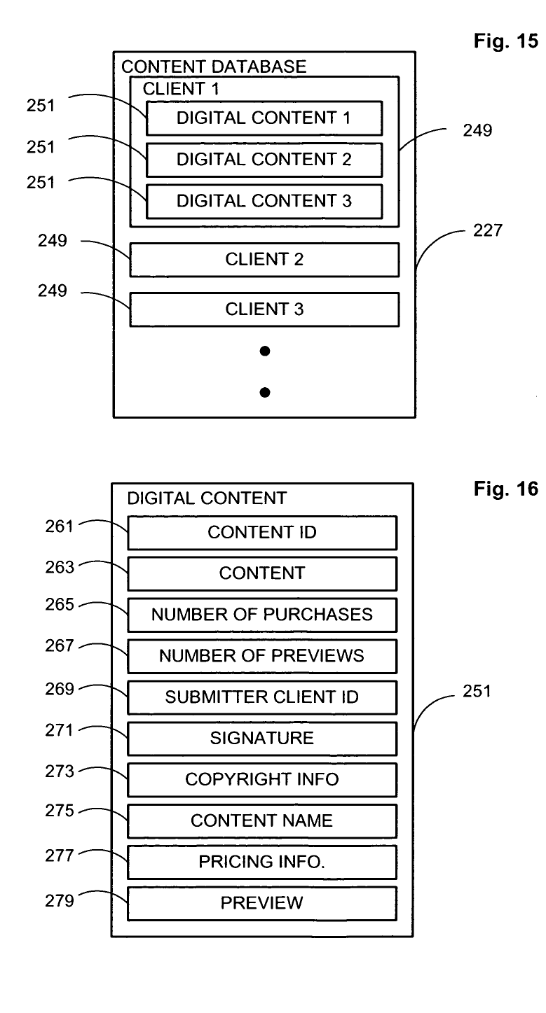

As shown in FIG. 15, the content database 227 stores a set 249 of digital content forms 251 for each client using the client computer 1, each digital content form 251 corresponding to a respective digital content file. As shown in FIG. 16, each digital content form 251 stores:
content ID information 261 storing the unique content ID assigned to the digital content file by the administration server 5;
content information 263 storing the digital content file itself;
number of purchases information 265 which stores the number of times the digital content file has been purchased from the client;
number of previews information 267 which stores the number of times a preview of the digital content file has been downloaded from the client;
submitter client ID information 269 storing the unique client ID for the original submitter of the digital content file;
signature information 271 storing the one-way hash for the digital content file generated using the secure hashing algorithm SHA-1;
copyright information 273 storing the details of the copyright of the digital content file;
content name information 275 storing the name assigned to the digital content file by the original submitter;
pricing information 277 storing the sale price of the digital content file; and
preview information 279 storing a preview of the digital content file.

The operations performed by the networked electronic trading system will now be described in more detail.

Client Registration Procedure

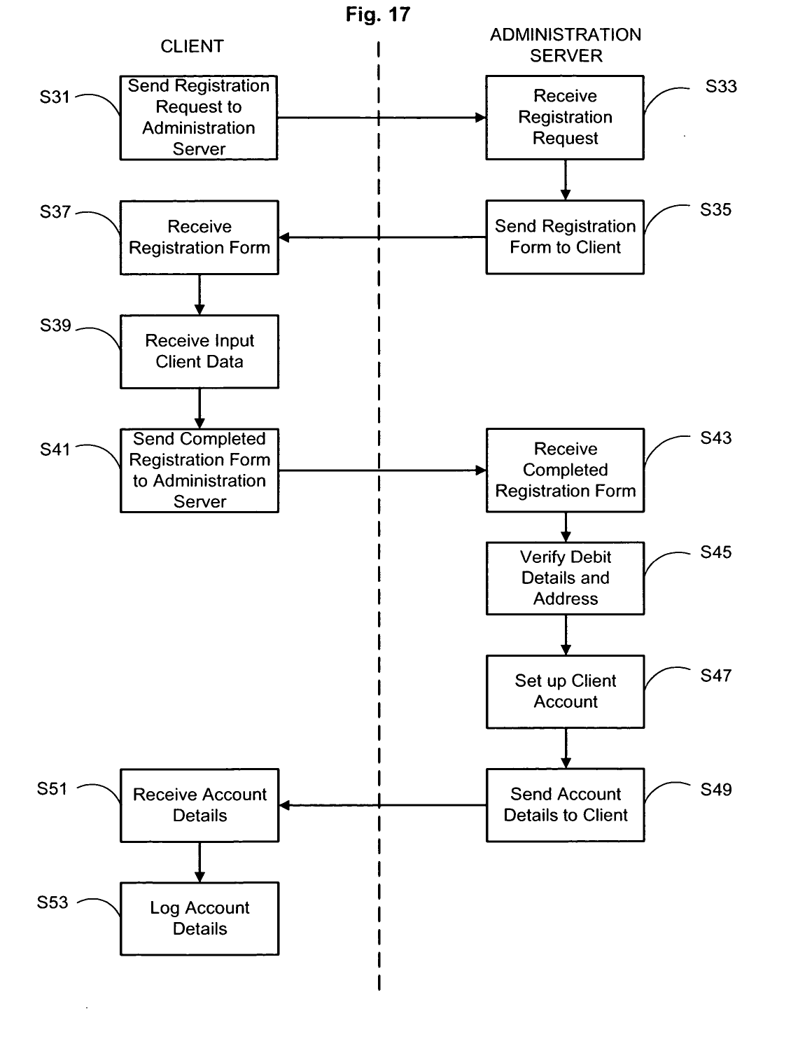

The manner in which new clients for the networked electronic trading system are registered will now be described with reference to FIG. 17.

In this embodiment, prior to registration a client loads client software onto a client computer 1. The client software includes the control module 205, the register client module 211, the purchase content module 213, the submit content module 215, the sell content module 217, the publish content module 219 and the play content module 221. The client software also includes an initialisation module which, when executed, sets up the account database 225 and the content database 227 and invites the client to initiate registration with the administration server 5.

In this embodiment, the client software may be downloaded from the internet or read from a data storage device such as the CD-ROM 209.

Once registration is initiated by the client, the register client module 211 is activated. First, the register client module 211 sends, at S31, a registration request to the administration server 5. On receiving the registration request (S33), the administration server 5 activates the register client module 33 and sends, at S35, a registration form to the client computer 1. The registration form includes input fields for entering the client's name, the debit details for the client, an address for the client, a network address for the client, a description for the client, a payment account for the client and a password for the client.

On receiving the registration form (S37), the register client module 211 prompts the client to enter the data for the registration form. After receiving the data input by the client (S39), the register client module 211 sends, at S41, the completed registration form to the administration server 5.

After receiving the completed registration form (S43), the administration server 5 verifies the debit details and the address given in the registration form for the client. In this embodiment, this is performed by the administration server 5 sending an electronic money transfer to the bank computer 7 debiting a small random charge from the bank account specified in the debit details for the client. When the client receives a statement from the bank 7 indicating the amount of the small random charge, the client sends a signal to the administration server 5 indicating the amount of the small random charge. If this amount is correct, then the debit details and the address have been verified and the small random charge is refunded.

After verifying the debit details and address, the administration server 5 assigns a unique client ID to the client and sets up, at S47, a client account in the client database. The administration server 5 then sends, at S49, the account details to the client. After receiving the account details (S51), the client computer logs, at S53, the account details in the account database 225.

The client is now in a position to submit digital content files to the networked electronic trading system, and to purchase or sell digital content files already submitted to the networked electronic trading system.

Digital Content Submission Procedure

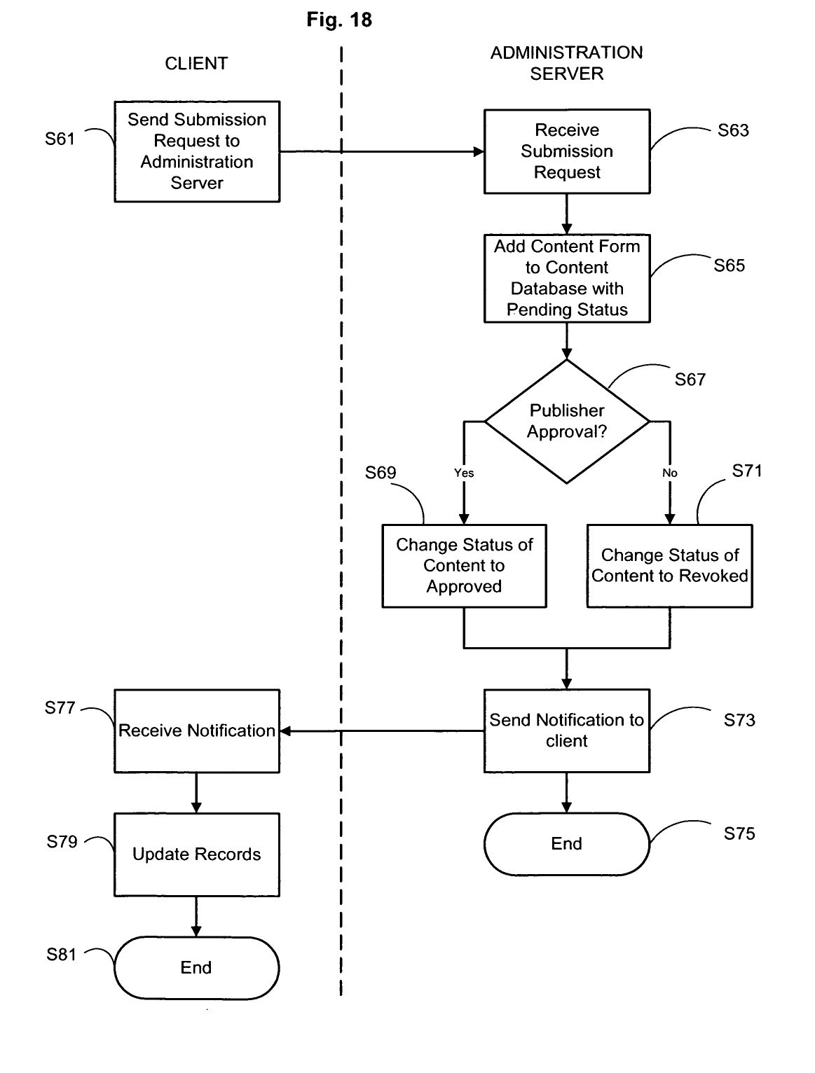

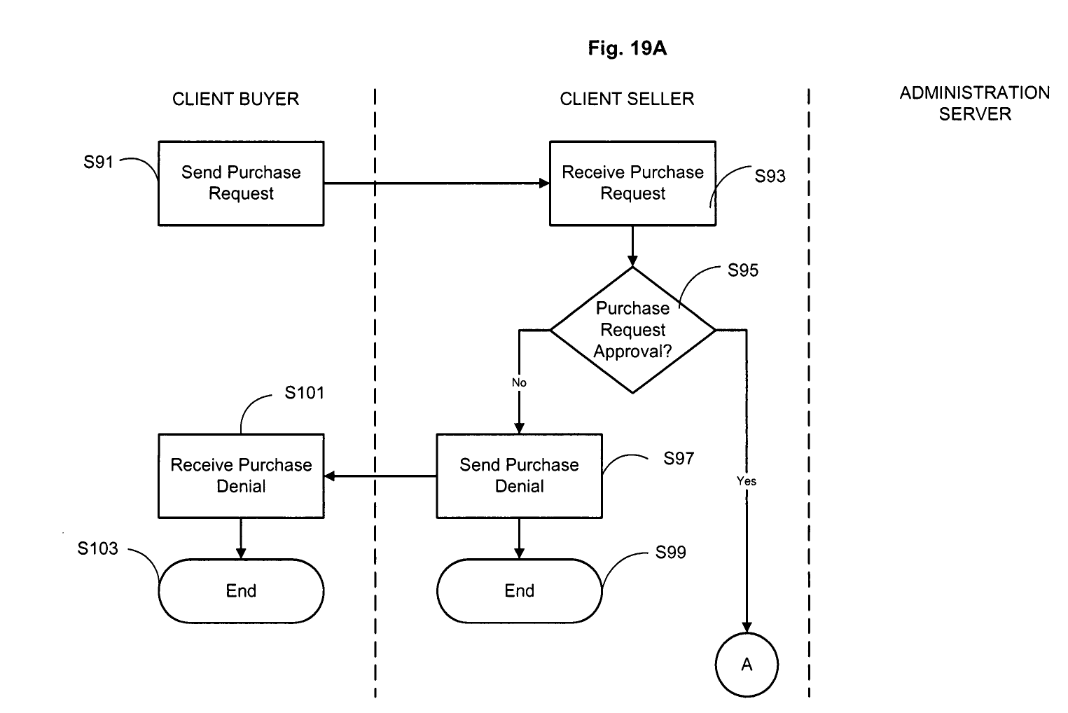

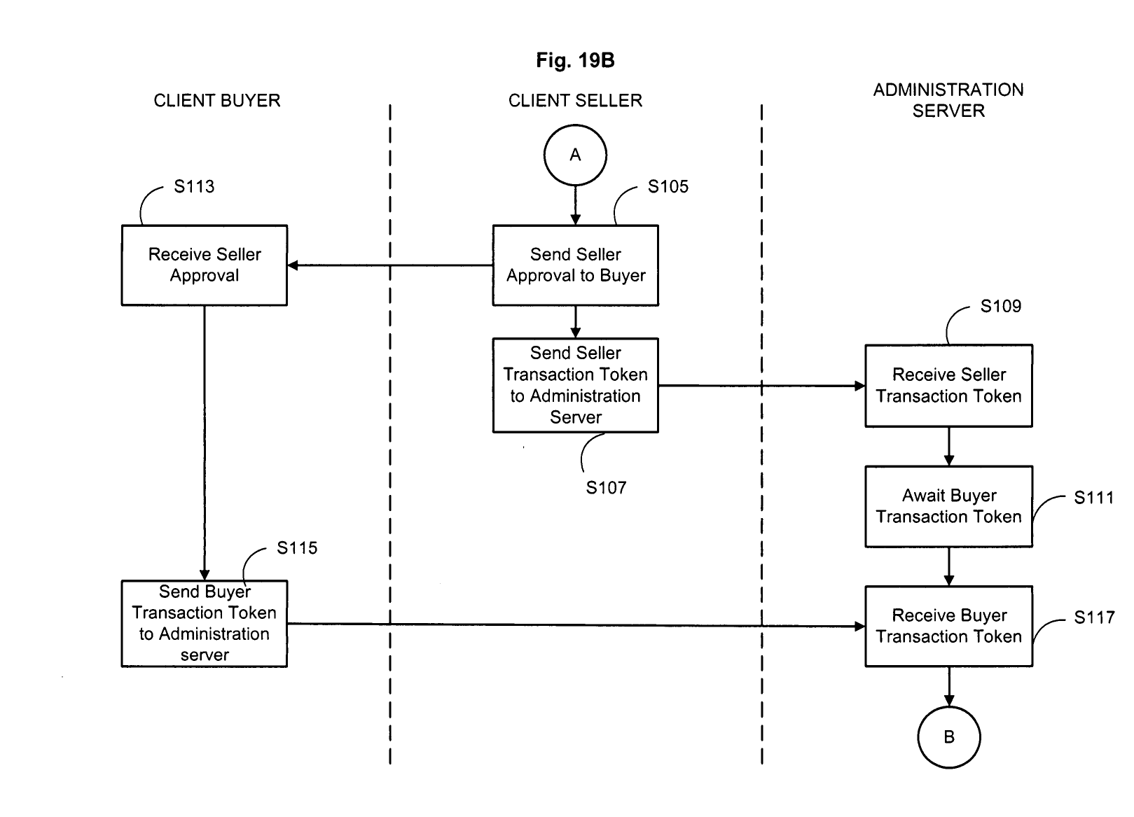

The procedure by which a digital content file is added to the networked electronic trading system will now be described with reference to FIG. 18. In this embodiment, the digital content file is generated by the digital data generator 13 of a client computer 1 and initially stored in the other files memory 229 of the client computer 1.

The content approval procedure is initiated by a client request, in response to which the control module 205 activates the submit content module 215 of the client computer 1. The client is then prompted to identify the digital content file within the other files memory 229 to be submitted, to assign a name and a type to the digital content file, and to provide copyright information for the digital content file including the identification of the copyright holders. The submit content module 215 also generates a content signature by processing the digital content file using the secure hashing algorithm SHA-1. The submit content module 215 then sends, at S61, a submission request to the administration server including the unique client ID, the content name, the digital content file, the content signature, the content type and the copyright information.

On receiving the submission request from the client computer 1 (S63), the administration server 5 activates the approve content module 39 which generates, at S65, a content form 101 for the newly submitted digital content file to the content database 49, with the status set to PENDING. The administration server 5 then initiates, at S67, a publisher approval process.

In this embodiment, pending content stored in the content database 49 may be browsed, using a web browser, by clients of the networked electronic trading system. In particular, a client can search for pending content in which the client has been acknowledged as a copyright holder and either approve the addition of the digital content file to the networked electronic trading system or refuse the addition of the digital content file to the networked trading system. If all copyright holders approve the addition of the digital content file, then the administration server 5 changes, at S69, the status of the content to APPROVED and generates revenues split information indicating payment amounts for the copyright holder(s) and the submitter and also an administration charge. If one or more copyright holders refuse addition of the digital content file, then the administration server 5 changes, at S71, the status of the content to REVOKED.

The administration server then sends, at S73, notification of the result of the publisher approval to the client and the revenue split and the content approval procedure run by the administration server then ends at S75. On receiving the notification from the administration server 5 (S77), if the received notification indicates that approval is granted then the submit content module 215 updates, at S79, the content database 227 to add a content form 251 for the submitted digital content file, setting the pricing information at a value on or above the total of the payments to the copyright holder(s) and the submitter and the administration charge, and updates the submitted content list stored in the account form 241 for the client and the submit content procedure on the client computer 1 ends at S81. If the received notification indicates that approval is not granted, then the submit content procedure ends immediately.

As discussed above, in this embodiment the submitter of a digital content file identifies copyright holders, and then the approval of the identified copyright holders is required before the digital content file can be traded on the networked electronic trading system. A dispute management procedure is available in case the submitter has incorrectly identified the copyright holders. When information concerning a dispute is received at the administration server 5, the manage dispute module 43 is initiated which changes the status of the corresponding content form 251 to DISPUTED, and generates a dispute form 171 in the disputed content database 51 storing the content ID of the disputed content, the reason for the dispute and contact details for the person originating the dispute. While the status of the content form is set to DISPUTED, the corresponding content cannot be traded on the networked electronic trading system.

The copyright dispute is then resolved in any suitable manner (e.g. mediation, arbitration or court proceedings).

After the dispute has been resolved, if the originator of the dispute has not been found to be a copyright holder then the status of the corresponding content file is simply reset to APPROVED. If the originator of the dispute is found to be a copyright holder but approves of the trading of the digital content file on the networked electronic trading system, then the status is reset to APPROVED, and the publisher client ID(s) information 129 and the revenue split 131 are adjusted accordingly. If the originator of the dispute is found to be a copyright holder and refuses approval of the trading of the digital content file on the networked electronic trading system, then the status of the digital content file is set to REVOKED and the publisher client IDs is updated with details of the true copyright holder(s).

Publication Procedure

In order to purchase digital content files, a client must first be able to identify the digital content files offered for sale by other clients. In this embodiment, initially this is done by a client activating browser software on the corresponding client computer which sends a search request to the administration server 5, which responds by activating the search content module 41. The search content module 41 allows the client use the browser software to search through the content database 49 for digital content files using standard database searching techniques. The client is also able to obtain details from the content database 49 of authorised sellers 133 of any digital content file. The client is then able to access the network address of an authorised seller of the digital content file.

When a client (hereafter called the client buyer) accesses the network address of another client (hereafter called the client seller), the client computer 1 of the client seller initiates the publish content module 219 which provides details of the digital content files stored in the content database 227 to the client computer 1 of the client buyer. In this embodiment, the information stored in the content database 227 of the client computer 1 of the client seller is presented on the client computer 1 of the client buyer using a template similar to the template employed by the iTUNES software provided by Apple Computer, Inc, but also including for each digital content file a “download preview” button, price information and a “buy” button.

When the “download preview” button for a digital content file is activated, a preview request is sent to the client computer 1 of the client seller which responds by transmitting the preview file to the client computer 1 of the client buyer, by incrementing the value stored in the number of previews information 267 in the digital content form 251 for the digital content file by one, and by sending a notification to the administration server 5. On receiving a preview download notification, the administration server 5 initiates the log previews module 40 which increments by 1 the value stored in the number of previews information 117 stored in the digital content form 101 in the content database 49 of the administration server 5. The information obtained by logging previews in this way can be used to adjust pricing. For example, if a digital content file is being previewed many times but rarely bought, then it is possible that by reducing the price many more copies will be sold and accordingly a greater profit will be realised.

Content Purchase Procedure

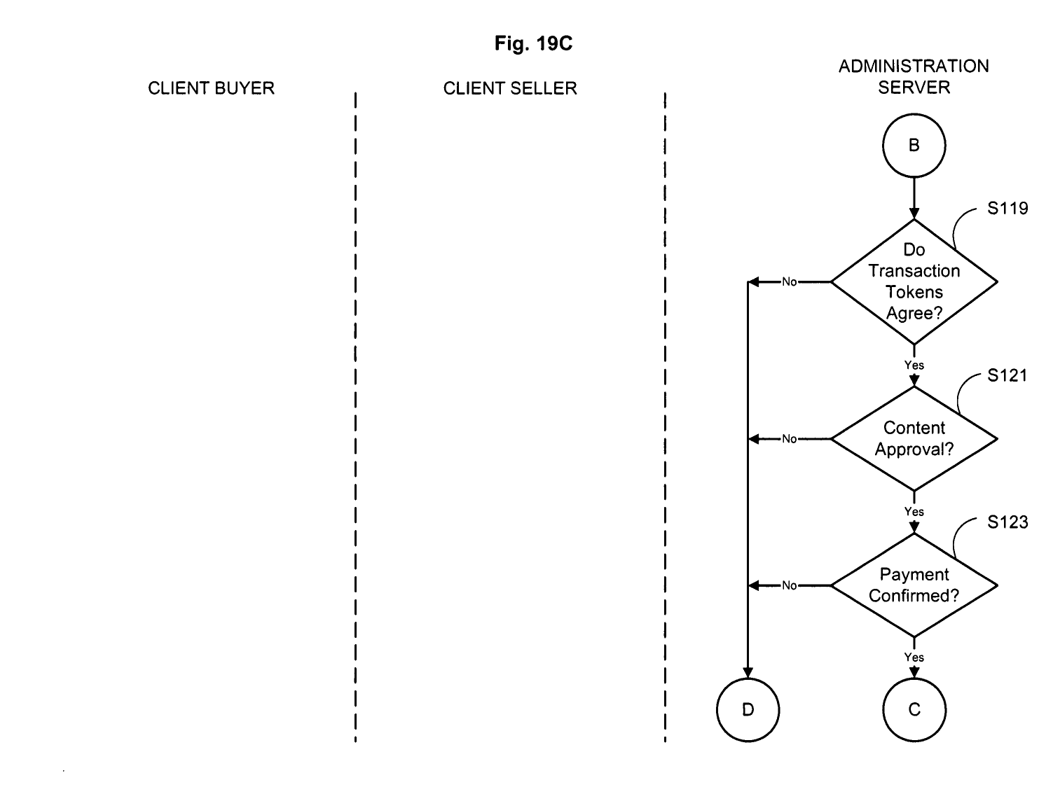

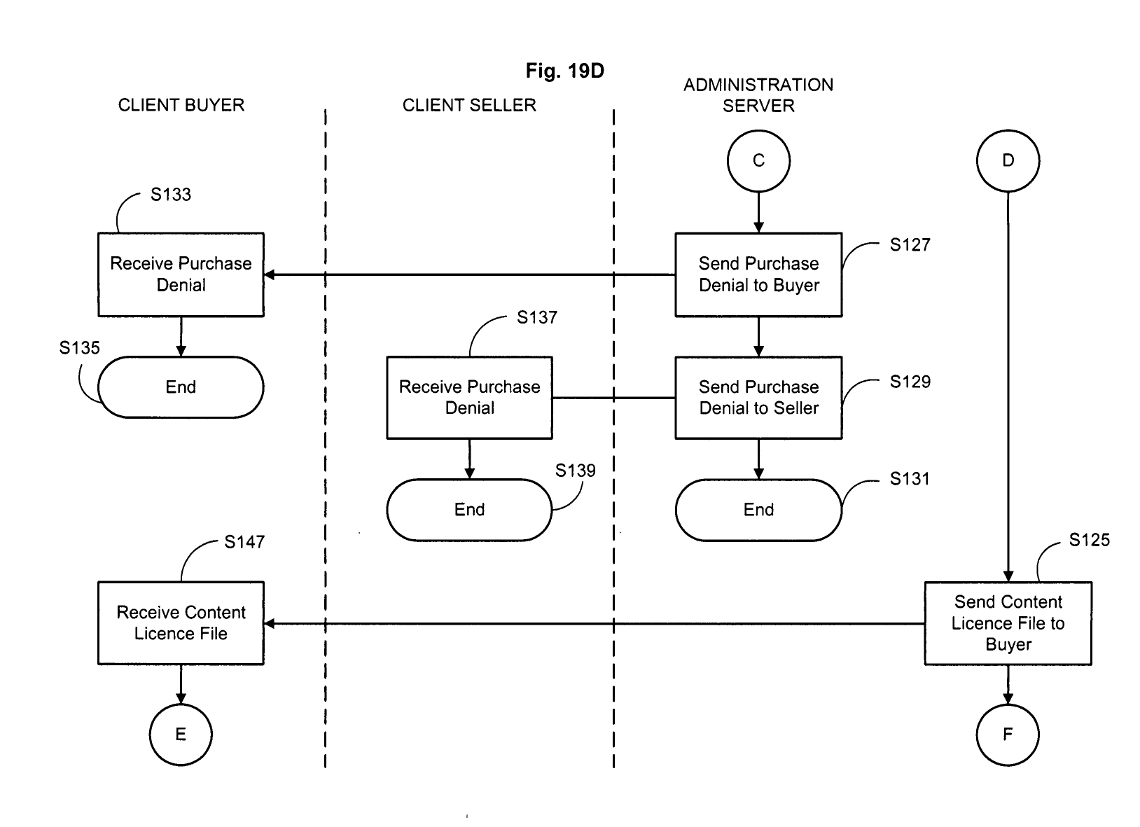

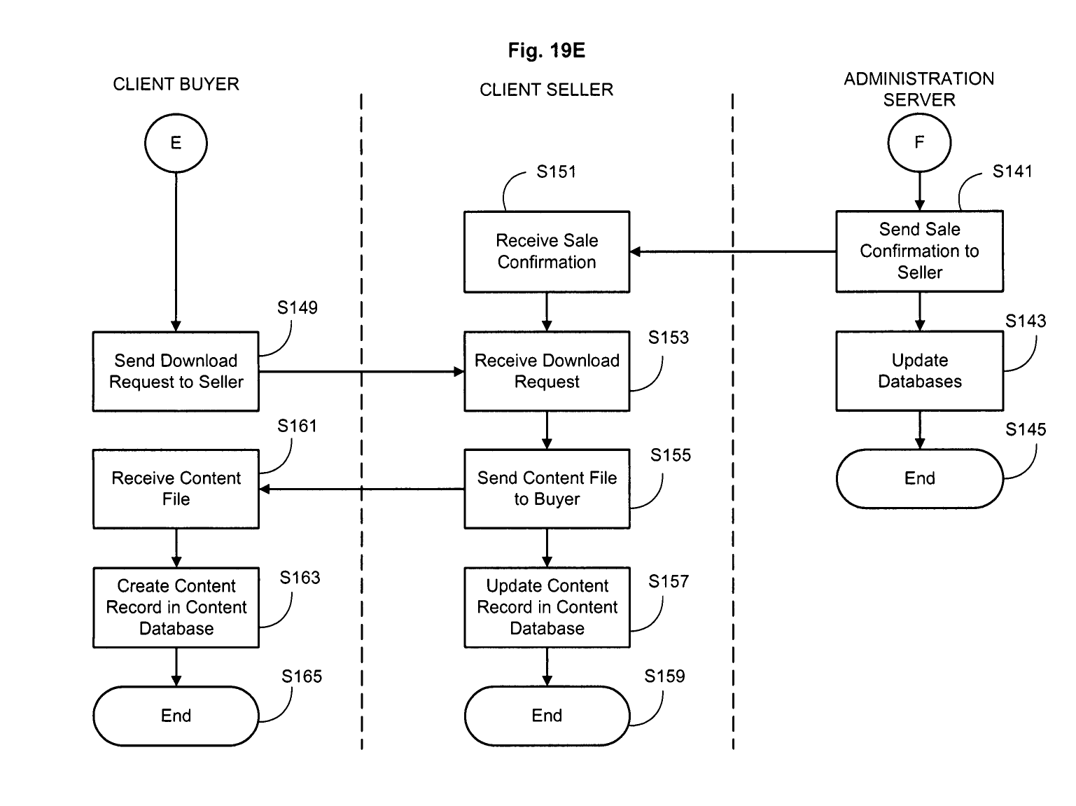

The manner in which content is traded over the networked electronic trading system will now be described with reference to FIGS. 19A to 19E.

The purchase procedure starts by the client buyer pressing the “buy” button which activates the purchase content module 213 stored on the client computer 1 of the client buyer. As shown in FIG. 19A, the purchase content module 213 of the client computer 1 of the client buyer sends, at S91, a purchase request to the client computer 1 of the client seller. On receiving the purchase request (S93), the sell content module 217 stored in the client computer 1 of the client seller is activated. The purchase content module 213 first checks whether the purchase request conforms to rules for transactions set by the client seller. These rules can include the exclusion of some client buyers, for example by geographical region, for either all or some digital content files. If the purchase request does not conform to the set rules, then the sell content module 217 sends, at S97, a purchase denial notification to the client buyer and execution of the sell content module 217 ends at S99. On receiving a purchase denial notification (S101), operation of the purchase content module 213 by the client computer 1 of the client buyer ends at S103.

If the sell content module 217 of the client seller finds that the purchase request conforms to the rules set by the client seller, then the sell content module 217 sends, at S105, a seller approval notification to the client computer 1 of the client buyer which includes the content signature for the digital content file. The sell content module 217 of the client seller then sends, at S107, a seller transaction token to the administration server 5. The seller transaction token contains the client ID of the client buyer, the client ID of the client seller, the unique content ID of the digital content file, the content signature of the digital content file and the price for the transaction.

On receiving the seller transaction token (S109), the administration server 5 initiates the approve purchase module 35. The administration server 5 then waits, at S111, for a buyer transaction token.

On receiving the seller approval notification from the client seller (S113), the purchase content module 213 of the client buyer sends, at S115, a buyer transaction token to the administration server 5. The buyer transaction token includes the same information as the seller transaction token. On receiving the buyer transaction token (S117), the approve purchase module 35 of the administration server 5 checks, at S119, if the information in the seller transaction token agrees with the information in the buyer transaction token.

If the buyer transaction token and the seller transaction token agree, then the approve purchase module 35 of the administration server 5 checks, at S121, that the status of the digital content file is set to APPROVED and that the client seller is one of the authorised sellers. This is done by checking that the client seller is identified in the authorised sellers information 133 of the content form for the digital content file, that the content is identified in the submitted content list 87 or the purchased content list 89 of the client form 61 for the client, and that the client is not excluded for any other reason (e.g. geographical location).

If the content and the client seller are both approved, then the approve purchase module 35 of the administration server 5 initiates the transfer of the transaction price from the bank account of the client buyer to the administration account 9 by sending an electronic payment instruction to the bank computer 7. If response to an electronic message from the bank computer confirming payment (S123), then the approve content module 39 sends, at S125, a content licence file to the client buyer. The content licence file identifies the content ID, the seller ID, the signature for the content, the copyright information for the content, the name of the content and the publisher ID(s) associated with the content. If the information provided by the seller transaction token and the buyer transaction token do not agree, or if the status of the content is not set to APPROVED, or if the seller is not an authorised reseller, or if the payment is not confirmed, then the approve purchase module 35 at the administration server sends, at S127, a purchase denial to the client buyer and sends, at S129, a purchase denial to the client seller. The operation of the approve purchase module 35 by the administration server 5 then ends at S131. On receiving a purchase denial from the administration server 5 (S131), the operation of the purchase content module 213 at the client computer 1 of the client buyer ends at S135. Similarly, on receiving a purchase denial notification from the administration server (S137), operation of the sell content module 217 by the client computer 1 of the client seller ends at S139.

After sending, at S125, a content licence file to the client buyer, the approve purchase module 35 at the administration server 5 sends, at S141, a sale confirmation notification to the client seller. The approve purchase module 35 then updates, at S143, the client database 45, the transaction database 47 and the content database 49. In particular, a transaction form 141 for the transaction is generated in the transaction database 47, the transaction lists stored in the client forms for the client buyer and the client seller are updated to include the new transaction, and the purchased content list stored in the client form for the client buyer is updated to include the content ID for the purchased digital content file. Further, the list of authorised sellers 133 stored in the content form 101 for the digital content file in the content database 49 is updated to include the details of the client buyer and the value stored in the number of purchases information 115 is incremented by one. After updating the databases, operation of the approved purchase module 35 by the administration server 5 ends at S145.

After the client computer 1 of the client buyer has received, at S147, the content licence file from the administration server 5, the purchase content module 213 sends, at S149, a download request to the client seller requesting the downloading of the digital content file. Subsequent to having received, at S151, the sale confirmation notification from the administration server 5, when the client computer 1 of the client seller receives, at S153, the download request from the client buyer the sell content module 217 at the client computer 1 of the client seller generates a copy of the digital content file and sends, at S115, the copy of the digital content file to the client buyer over the network 3. The client computer 1 of the client seller then updates, at S157, the content form 251 in the content database 227 by incrementing the value stored in the number of purchases information 265 by one. The sell content module 217 then ends at S159.

On receiving, at S161, the copy of the digital content file, the purchase content module 213 at the client computer 1 of the client buyer creates, at S163, a content form 251 in the content database 227 for the new digital content file. When creating the content form 251, the buyer is able to set a sale price in the pricing information 277 which must be at or above the total of the payments for the copyright holder(s) and the submitter and the administration charge. The purchase content module 213 then ends at S165.

After the content form for the new digital content file is generated in the content database 227 of the client computer 1 of the client buyer, the client buyer is able to play the content using the play content module 221.

In this embodiment, the content module 25 at the administration server 5 periodically, in accordance with signals from the clock module 31, initiates the payment module 37 to pay outstanding royalty payments, submitter payments and sale payments. In particular, the payment module 37 identifies outstanding transactions in the transaction database 47, identifies the recipients of the royalty payment, the submitter payment and the sale payment using the content database 49 and the client database 45, and sends electronic payment instructions to the bank computer 7 to transfer the amounts from the administration account 9 into the client accounts 11 for the recipients identified in the client database 45.

In this embodiment, as an added precaution, no royalty payments, submitter payments and sale payments are made from the administration account 9 for transactions relating to a digital content file in the six months following submission of the digital constant file. In this way, if the ownership of the copyright is disputed in the first six months then payment can be withheld until the copyright ownership issue has been settled.

Modifications and Further Embodiments

In the described embodiment, the digital content files are generated at the client computers using widely available software programs. It will be appreciated that these software programs could also import digital content files from external sources. It is envisaged that, for example, the networked electronic trading system would provide a good forum for independent musicians and film makers to sell original products. However, the networked electronic trading system could also have record companies or film distributors as clients, in which case the digital content files could be generated by state of the art media equipment.

It is envisaged that digital content files will generally be submitted by the originator of the digital content file. However, this is not essential. Indeed, the digital content file could be an illegitimate copy in which case, if the relevant copyright holders agree, by adding the digital content file to the networked electronic trading system the digital content file could become legitimised. This is in accordance with the aim of allowing individuals to profit from selling copies of files providing that the appropriate copyright payments are made.

In an alternative embodiment, if a submitter does not know copyright information then the digital content file can be submitted without copyright information. The administration server then only approves the digital content file for trading if copyright information is provided by a third party browsing the pending content database.

In an alternative embodiment, clients are able to browse the pending digital content files stored in the administration server and indicate an intent to purchase if the digital content file is approved. The administration server logs each intent to purchase, so that the copyright holder(s) can assess the likely demand for the digital content file. If the demand is high, this would be an incentive for the copyright holder(s) approve the digital content file for addition to the networked electronic trading system.

Although in the described embodiment, a client finds a digital content file by first searching through the content database of the administration server to identify network addresses for authorised sellers of the digital content file, if the client already knows a network address for a client who is likely to store the digital content file, the client can directly access the network address without first searching at the administration server.

In the described embodiment, in order to access and purchase digital content files from a client seller, a client buyer communicates with the client computer for the client seller. It will be appreciated that alternatively a client could set up a website at a remote server with the functionality for the buying and selling. In this way, the website becomes an online shop at which digital content files can be bought. An advantage of using a remote web server in this way is that network traffic at the client computer 1 is reduced.

In another embodiment, clients group together to form file sharing arrangements wherein if a digital content file is purchased from one client in the group, the digital content file can be downloaded in segments with different segments coming from different members in the group. Such an arrangement also has the advantage that network traffic at individual client computers is reduced.

In principle, once the purchase has been approved and the digital content file has been issued by the administration server 5 to the client buyer, the client buyer could download the digital content file from any client who is an authorised seller of the digital content file. In this way, the digital content file could be downloaded from the authorised seller having the best network connection to the client buyer. However, individual clients may establish a purchase rule which states that only digital content files bought from that client may be downloaded from the client computer 1 of that client.

It will be appreciated that many Internet Service Providers operate proxy server systems in which frequently-downloaded files are stored at a proxy server. When a request is sent to a website for a file stored in the proxy server, then the file is downloaded from the proxy server rather than the website. Such a system could be used for this invention.

In general, it is desired to limit network traffic at the administration server 5, and therefore normally a client is not allowed to download a digital content file from the administration server 5. In an embodiment, an exception to this occurs when a digital content file on a client computer 1 becomes corrupted; in which case another copy of the digital content file can be downloaded from the administration server 5 providing the client is an authorised seller of the digital content file.

In the described embodiment, after the administration server has approved the purchase of a digital content file, the digital content file is downloaded over the network by the client buyer. Alternatively, the digital content file could be stored on a storage medium such as a CD-ROM, and the storage medium could be physically transferred to the client buyer. This could be attractive if the digital content file is very large, for example a digitised film.

In the described embodiment, the SHA-1 hashing algorithm is used to generate a digital signature which is representative of the content of a digital content file. It will be appreciated that the digital signature could be generated in other ways, for example using a different hashing algorithm. Further, the use of a digital signature is not essential.

While the described networked electronic trading system does not apply any form of digital rights management to the digital content files themselves, this could be done as an extra precautionary measure. For example, this could be useful if a purchaser of a digital content file distributes illegal copies not approved by the administration server 5.

The networked electronic trading system could be extended to cover the trading of goods other than digital content files. In this case, the purchase request sent to the administration server 5 specifies the number and the type (e.g. physical object or digital content file) of the content.

It will be appreciated that instead of debiting money direct from client bank accounts, the administration server could debit money from client credit card accounts. Alternatively, money could be debited from a Nochex account, a Paypal account or the like.

It will be appreciated that to improve security, all network communications between client computers and between a client computer and the administration server could be encrypted, for example using a protocol like the Secure Sockets layer or secure-HTTP.

In the above description the terms “client buyer” and “client seller” are used only to distinguish the parties of a transaction. A client buyer for one transaction could be a client seller for a different transaction, and similarly a client seller for one transaction could be a client buyer for a different transaction.

Although the client computer and the administration server in the described embodiment are implemented by running software on a conventional computing apparatus, it will be appreciated that alternatively dedicated hardware apparatuses could be used. In another alternative embodiment, the client computer is implemented in an interactive television system.

Although the embodiment of the invention described with reference to the drawings comprises computer apparatus and processes performed in the computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for using in the implementation of the processes according to the invention.

The carrier may be any entity or device capable of carrying the program. For example, the carrier may comprise a storage medium, such as a ROM, for example a CD-ROM or a semiconductor ROM, or a magnetic recording medium, for example a floppy disc or a hard disc, or an optical recording medium. Further, the carrier may be a transmissible carrier such as an electronic or optical signal which may be conveyed via electrical or optical cable or by radio or other means.

When the program is embedded in a signal which may be conveyed directly by cable or other device or means, the carrier may be constituted by such cable or other device or means. Alternatively, the carrier may be an integrated circuit in which the program is embedded, the integrated circuit being adapted for performing, or for use in the performance of, the relevant processes.

Although in the described embodiments the invention is implemented by software, it will be appreciated that alternatively the invention could be implemented by hardware devices or a combination of hardware devices in software.

1. A network apparatus for administering a networked electronic trading system, the network apparatus comprising:
a database operable to store information for a plurality of electronic data files, the information for each electronic data file including a list identifying registered traders of the electronic data file; and
a transaction request processor operable to process transaction request information received from one or more remote network devices, the transaction request identifying a buyer, a seller and an electronic data file,
wherein the transaction request processor is operable i) to approve the sale of said identified electronic data file by the seller to the buyer at least partially in dependence upon if the seller identified in the received transaction request is identified in the registered traders list for said identified electronic data file, and ii) if the transaction is approved, to add information identifying the buyer to the registered traders list for said identified electronic data file.

2. A network apparatus according to claim 1, wherein the transaction request processor is operable to verify payment of a transaction charge associated with the transaction request, and to approve the transaction in dependence upon the verification of payment of the transaction charge.

3. A network apparatus according to claim 1, wherein the database is operable to store status information for each electronic data file, and
wherein the transaction request processor is operable to approve the transaction in dependence upon the status information stored in the database for the electronic data file identified in the transaction request.

4. A network apparatus according to claim 1, wherein for a single transaction, the transaction request processor is operable to receive a first transaction request from a first remote network device associated with the buyer and a second transaction request from a second remote network device associated with the seller, and to approve the transaction in dependence on a comparison of the information conveyed by the first transaction request and the information conveyed by the second transaction request.

5. A network apparatus according to claim 1, wherein for each electronic data file, the database is operable to store information identifying one or more corresponding copyright holders and revenue information identifying how to distribute a transaction charge for the electronic data file,
and wherein the network apparatus further comprises a payment calculator operable to calculate for each transaction a first payment amount for the one or more copyright holders and a second payment amount for the seller in accordance with the revenue information.

6. A network apparatus according to claim 1, further comprising a content approver operable to approve the addition of an electronic data file submitted by a submitter to the database,
wherein information identifying the submitter is added to the registered traders list for the new electronic data file.

7. A network apparatus according to claim 5,
wherein the payment calculator is operable to calculate for each transaction a third payment amount for the submitter in accordance with the revenue information.

8. A network apparatus according to claim 1, further comprising an electronic data file registration module operable to register information for a new electronic data file in the database.

9. A network apparatus according to claim 1, wherein the database is operable to store information associated with a plurality of clients of the networked electronic trading system, and
wherein the network apparatus further comprises a client registration module operable to register information for a new client in the database.

10. A network apparatus according to claim 1, wherein in response to approval of a transaction by the transaction request processor, the network apparatus is operable to send a purchase approval message to one or both of the buyer and the seller.

11. A network device for a networked electronic trading system, the network device being associated with a first client of the networked electronic trading system and comprising:
a network server operable to provide information identifying electronic data files stored by the network device to a remote network device associated with a second client of the networked electronic trading system; and
a data transfer request processor operable to process a received data transfer request received from the second client identifying an electronic data file stored by the network device,
wherein the data transfer request processor is operable to determine if the transfer of the electronic data file identified by the transfer request is approved by a remote trading system administration apparatus, and to transfer at least part of said identified electronic data file to the second client if it is determined that the transfer is approved.

12. A network device according to claim 11, wherein the data transfer request processor comprises a transaction request generator operable to generate a transaction request identifying the first and second clients and the electronic data file identified by the transfer request, and to send the transaction request to the trading system administration apparatus.

13. A network device for a networked electronic trading system, the network device being associated with a first client of the networked electronic trading system and comprising:
a browser operable to view index information identifying electronic data files stored at a remote network device by a second client of the networked electronic trading system;
a selector operable to select an electronic data file at the remote network device for purchase; and
a transaction request generator operable to generate a transaction request identifying the first and second clients and the electronic data file selected by the selector, and to transmit the transaction request to a remote trading system administration apparatus for approval.

14. A network device according to claim 13, wherein the browser is a website browser.

15. A network device according to claim 13, further comprising a purchase request generator operable to generate a purchase request identifying electronic data file selected by the selector and the first client, and to send the purchase request to the remote network device associated with the second client.

16. A network device according to claim 11, further comprising a content submitter for submitting an electronic data file to the remote trading system electronic apparatus for inclusion in the networked electronic trading system.

17. A networked electronic trading system comprising a plurality of trader network devices, each trader network device being associated with one or more traders of the networked electronic trading system, and a trading system administration network apparatus comprising:
a database operable to store information for a plurality of electronic data files, the information for each electronic data file including a list identifying registered traders of the electronic data file; and
a transaction request processor operable to process a transaction request received from a trader network device, the transaction request identifying a buyer, a seller and an electronic data file,
wherein the transaction request processor is operable i) to approve the sale of the said identified transaction request at least partially in dependence upon if the seller identified in the received transaction request is identified in the registered traders list for said identified electronic data file, and ii) if the sale is approved, to add information identifying the buyer to the registered traders list for the identified electronic data file.

18. A storage device storing instructions including instructions for programming a programmable processing apparatus to operate as a network apparatus for administering a networked electronic trading system, the network apparatus comprising:
a database operable to store information for a plurality of electronic data files, the information for each electronic data file including a list identifying registered traders of the electronic data file; and
a transaction request processor operable to process transaction request information received from one or more remote network devices, the transaction request identifying a buyer, a seller and an electronic data file,
wherein the transaction request processor is operable i) to approve the sale of said identified electronic data file by the seller to the buyer at least partially in dependence upon if the seller identified in the received transaction request is identified in the registered traders list for said identified electronic data file, and ii) if the transaction is approved, to add information identifying the buyer to the registered traders list for said identified electronic data file.

19. A storage device storing instructions including instructions for programming a programmable processing apparatus to operate as a network device for a networked electronic trading system, the network device being associated with a first client of the networked electronic trading system and comprising:
a network server operable to provide information identifying electronic data files stored by the network device to a remote network device associated with a second client of the networked electronic trading system; and
a data transfer request processor operable to process a received data transfer request received from the second client identifying an electronic data file stored by the network device,
wherein the data transfer request processor is operable to determine if the transfer of the electronic data file identified by the transfer request is approved by a remote trading system administration apparatus, and to transfer at least part of said identified electronic data file to the second client if it is determined that the transfer is approved.

20. A signal conveying instructions including instructions for programming a programmable processing apparatus to operate as a network apparatus for administering a networked electronic trading system, the network apparatus comprising:
a database operable to store information for a plurality of electronic data files, the information for each electronic data file including a list identifying registered traders of the electronic data file; and
a transaction request processor operable to process transaction request information received from one or more remote network devices, the transaction request identifying a buyer, a seller and an electronic data file,
wherein the transaction request processor is operable i) to approve the sale of said identified electronic data file by the seller to the buyer at least partially in dependence upon if the seller identified in the received transaction request is identified in the registered traders list for said identified electronic data file, and ii) if the transaction is approved, to add information identifying the buyer to the registered traders list for said identified electronic data file.

21. A signal conveying instructions including instructions for programming a programmable processing apparatus to operate as a network device for a networked electronic trading system, the network device being associated with a first client of the networked electronic trading system and comprising:
a network server operable to provide information identifying electronic data files stored by the network device to a remote network device associated with a second client of the networked electronic trading system; and
a data transfer request processor operable to process a received data transfer request received from the second client identifying an electronic data file stored by the network device,
wherein the data transfer request processor is operable to determine if the transfer of the electronic data file identified by the transfer request is approved by a remote trading system administration apparatus, and to transfer at least part of said identified electronic data file to the second client if it is determined that the transfer is approved.
